(19) United States
(12) Patent Application Publication
(10) Pub. No.: US 2013/0061820 A1
(43) Pub. Date: Mar. 14, 2013

(54) MOVABLE TARGET FOR TRAINING AND PROVING WITH MULTIPLE APPLICATIONS

(71) Applicant: Larry Lance Earl, Rockland, ID (US)

(72) Inventor: Larry Lance Earl, Rockland, ID (US)

(21) Appl. No.: 13/597,690

(22) Filed: Aug. 29, 2012

Related U.S. Application Data
(60) Provisional application No. 61/573,201, filed on Aug. 31, 2011.

(51) Int. Cl. A01K 15/02; F41J 9/00

(52) U.S. Cl. 119/839; 273/454

(57) ABSTRACT

A movable target for training and proving with multiple applications comprising a movable target which can be moved at multiple speeds, and in multiple directions, and for multiple distances to simulate the natural movements of actual moving objects. Said movable target control and operation may be accomplished through a control interface, including but not limited to a remote transmitter or a control panel. Said target movements may be controlled by activating or creating programmed runs or by manual operation. Said user interface may be used to manually control said movable target behavior.

This application claims priority to U.S. Provisional Patent 61/573,201, filed Aug. 31, 2011

### BACKGROUND

Historically, many activities require a conditioned response to a moving object. These activities include, but are not limited to, the management of cattle from horseback, the handling of stock animals by stock dogs, harvesting moving game animals with archery, firearms and other weapons, firearms training, and firearms competitions. Achieving proficiency and accuracy in these, and other activities requires significant levels of training against a moving target that is capable of realistically moving in a way that simulates the movement of actual moving objects.

### SUMMARY OF INVENTION

Historically, the development the skills required to deal with a moving object has often been accomplished with the use of non-moving objects. Effective training is not possible when the object of the training is unable to act in a manner that realistically simulates actual moving objects.

According to an embodiment, the current invention is a device comprising: a movable target; at least one user interface configured to provide user control of the movable target; and, electronic components configured to control behavior of the movable target.

According to an embodiment, multiple programmed runs are configured to produce random said movable target behavior while maintaining predictable said target behavior characteristics.

According to an embodiment, multiple programmed runs are configured to produce non-random said movable target behavior while maintaining predictable target move characteristics.

According to an embodiment, a user may create custom said programmed runs by independent configuration of run parameters.

According to an embodiment, the programmed runs may be configured to control the movable target in a way that simulates the actions of live cattle in known or established equine competitive events, (for example: cutting classes offered by the National Cutting Horse Association or fence classes offered by the National Reined Cow Horse Association).

According to an embodiment, the programmed runs may be configured to control the movable target in a way that simulates the actions known to be common among criminals and enemy combatants, for purposes of firearms proficiency training.

According to an embodiment, the programmed runs may be configured to control the movable target in a way that simulates the actions of known game animals, for purposes of hunter proficiency training.

According to an embodiment, elements of said random target behavior may be eliminated or modified by activating run modifiers.

According to an embodiment, said user interface may be used to interact with the programmed runs to modify said target behavior while the programmed run is in progress. Interfaces may include control panels, remote transmitters or any known method that may provide instructions to the device.

According to an embodiment, the user interface may be used to independently move the movable target in multiple directions and at a plurality of user selectable speeds and for a plurality of user selectable move distances.

According to an embodiment, a vending method is provided to allow a user to activate the device for limited usage in exchange for a value received.

Said user interfaces may include control panels, remote transmitters or any known method that may provide instructions to the device.

### BRIEF DESCRIPTION OF DRAWINGS

FIG. 1 illustrates one possible embodiment of the invention comprising an enclosure 1, a drive motor 3, control circuitry 2, a drive pulley 7, a transport line 8, a target 9, an idler pulley 10, and a user interface 4 comprising a display panel 5 and control buttons 6. Additional embodiments may include a variety of drive devices including but not limited to sprockets and chains. The transport line 8 may be made of any suitable material such as a rope, cable, cord or chain.

FIG. 2 illustrates one possible embodiment of the remote control RF(radio frequency) user interface comprising a system enclosure 21, and control buttons 22. FIG. 2 also illustrates the user interface mounted on a human hand 23.

FIG. 3 illustrates one possible method of the restricted use vending function.

FIG. 4 illustrates one embodiment of programmed run processes that may be configured to produce predictability in a programmed run; may be configured to produce randomness in a programmed run; may be used to restrict random elements of a programmed run in order to narrow the magnitude of random activity, and may be configured to allow user interaction with a programmed run while the programmed run is active. These configuration options allow the user to create a desired blend of random and predictable target 9 behavior.

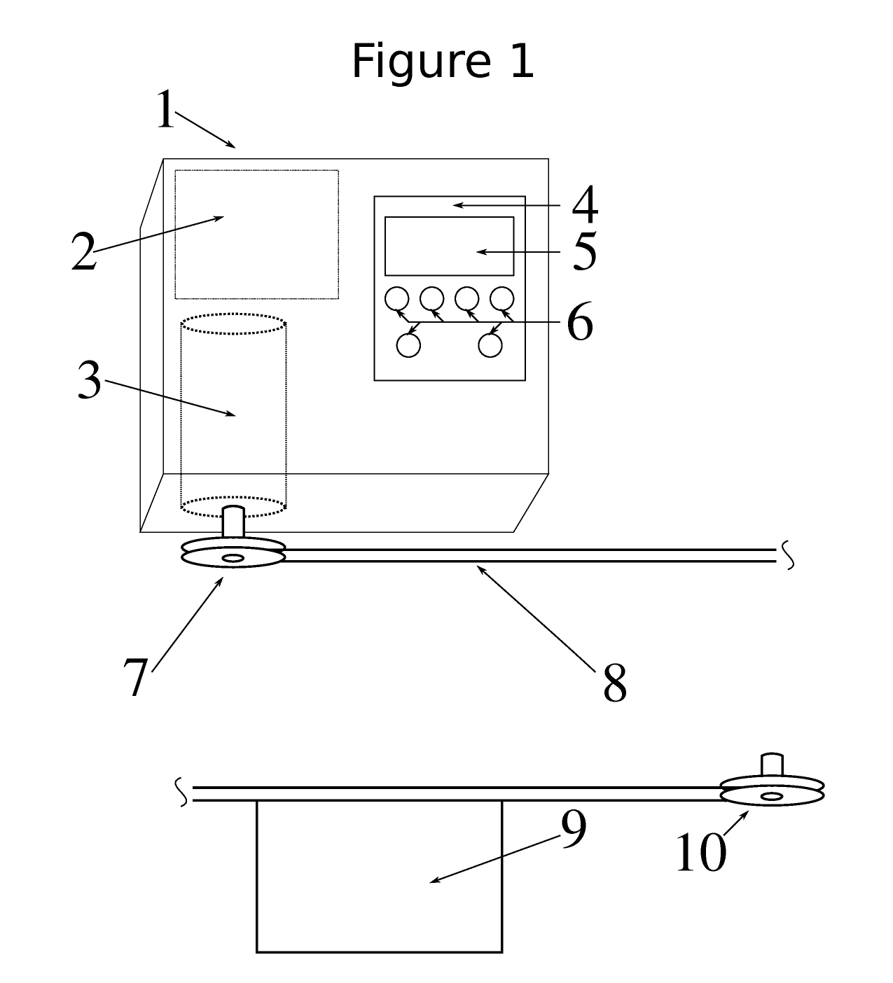

FIGS. 1, 2, 3, and 4 are presented as embodiment examples only.

FIGS. 1, 2, 3, and 4 are not intended to limit the scope of the present invention.

### DETAILED DESCRIPTION

In the following description, the use of “a”, “an”, or “the” can refer to the plural. AU examples given are for clarification only, and are not intended to limit the scope of the invention.

Referring to FIG. 1, according to an embodiment, the invention includes a system enclosure 1 that houses electrical and mechanical components comprising electrical circuitry 2, a drive motor 3, and a control panel 4 comprising a display 5 and control buttons 6 . The drive motor 3 shaft extends through the enclosure 1 and is attached to a drive pulley 7. When the drive pulley 7 is rotated by the drive motor 3, the drive line 8 moves around the idler pulley 10 and back toward the drive pulley 7. Movement of the drive line 8, creates a movement of the movable target 9. The drive pulley 7 may be rotated in a clockwise or counter clockwise direction. Rotation of the drive pulley 7 may be at one or more speeds.

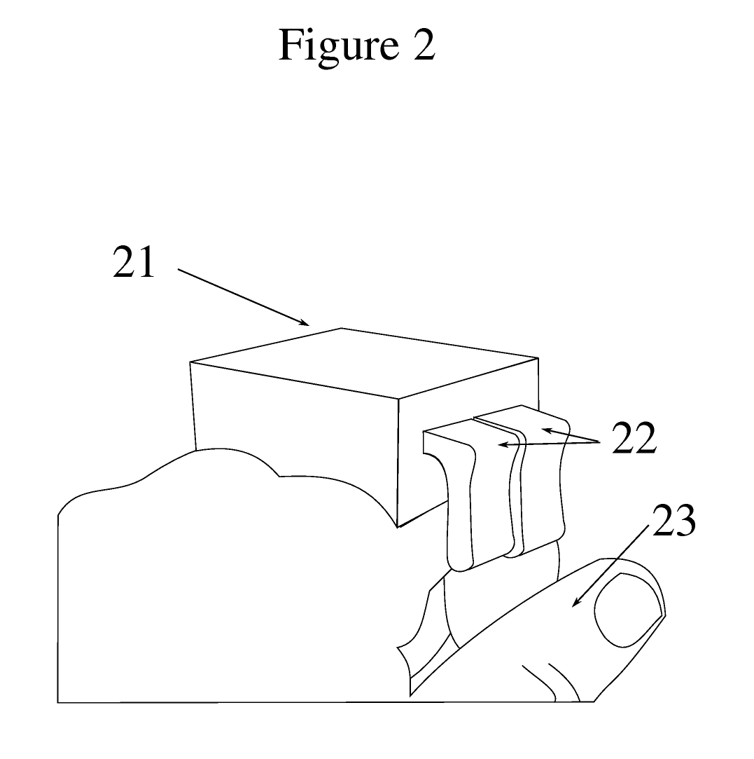

Referring to FIG. 2, according to an embodiment, shows a remote transmitter assembly. A transmitter enclosure 21 is attached to the back of the index and middle finger of a human hand 23. Control buttons 22 extend out of the enclosure and are configured to be pressed by the human hand 23. This embodiment has been configured to allow the user to manipulate the control buttons without losing the use and functionality of the hand 23, thereby allowing the user to manipulate the transmitter assembly while using the same hand 23 for other purposes. The transmitter assembly will allow the user to control various functions of the invention.

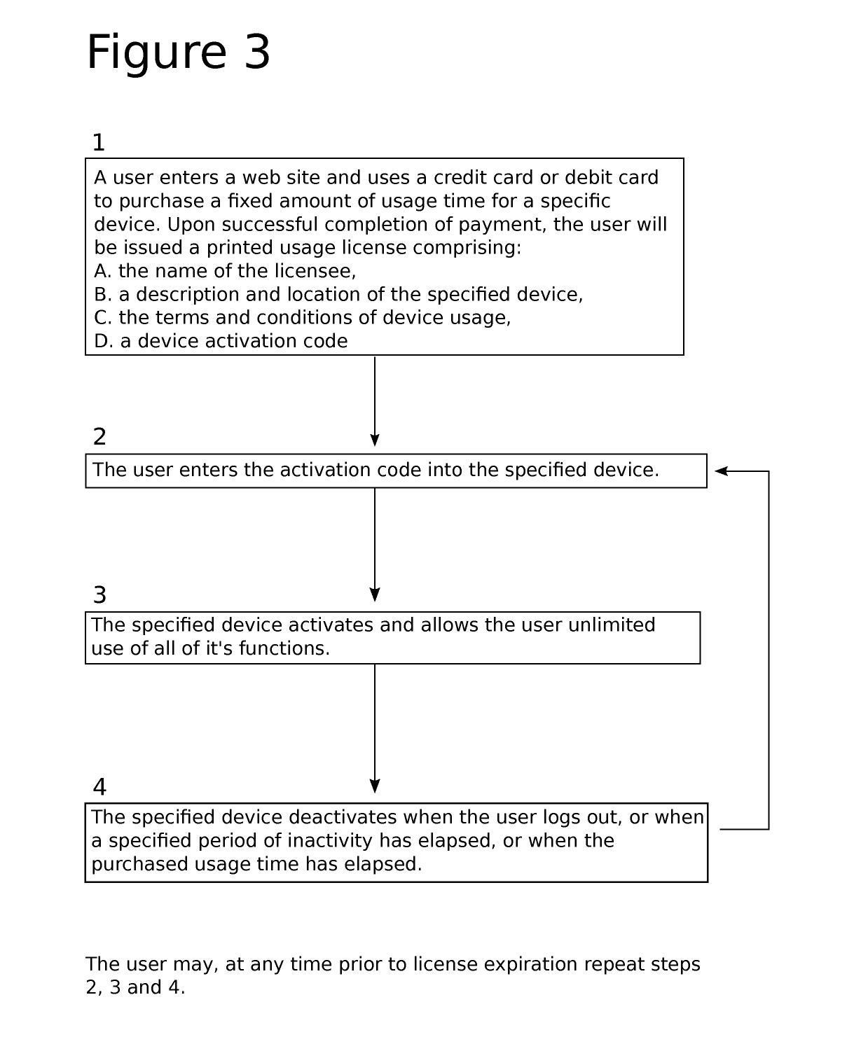

Referring to FIG. 3, according to an embodiment, shows a flow chart that illustrates how a user may purchase time to use the invention and how the user may activate and use the invention.

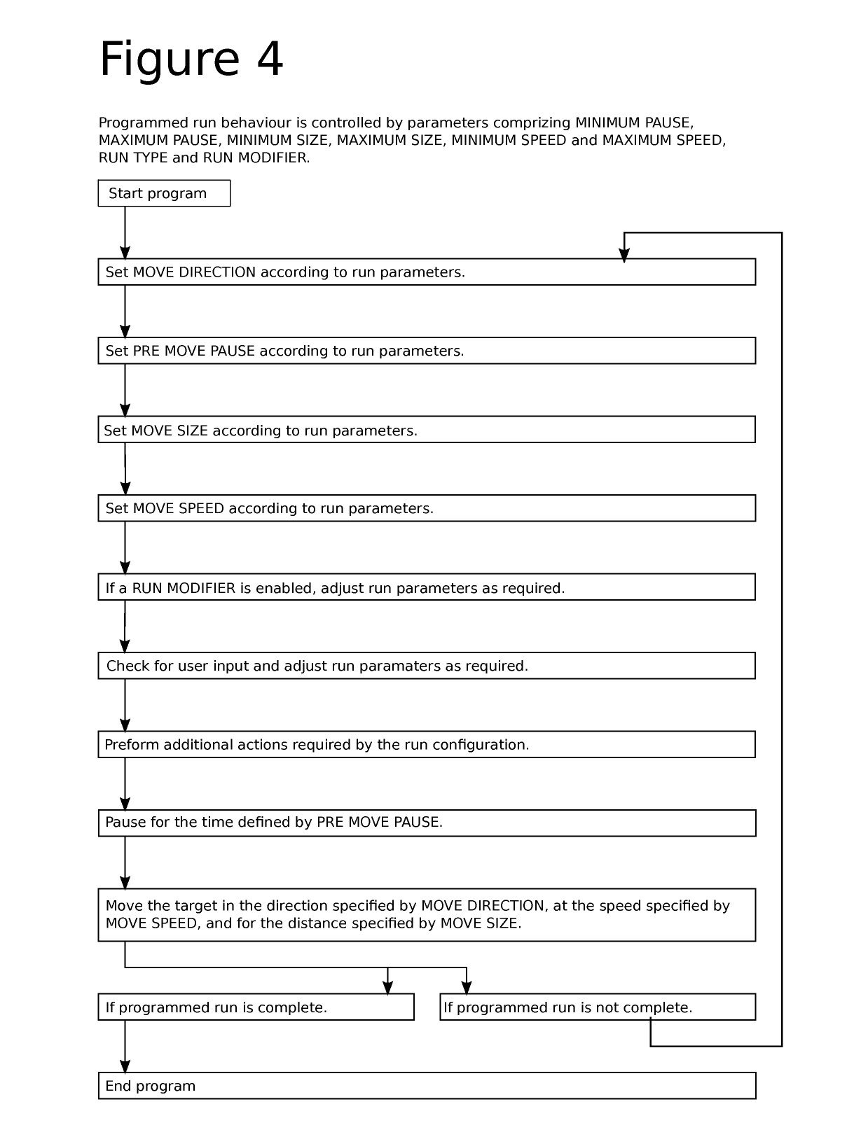

Referring to FIG. 4, according to an embodiment, shows a flow chart that illustrates the flow of a programmed run.

The invention, according to an embodiment, includes one or more pre-programmed runs. Each pre-programmed run is governed by run parameters that control the duration of the pre-move pause, the direction of the move, the size of the move, and the speed of a move. These run parameters are programmed into the system and may not be modified by the user.

The invention, according to an embodiment includes one or more user programmable custom runs. Each custom run is governed by run parameters that control the duration of the pre-move pause, the direction of the move, the size of the move, and the speed of a move. These run parameters are set by the user and may be modified at any time by the user.

The parameters for the pre-programmed runs and the programmable custom runs which define the pre-move pause, the move direction, the move size, and the move speed may be configured as a single value to cause the target 9 behavior to be non-random, or configured to cause the invention to randomly select the parameters from a range of user defined values to cause random parameter selection, resulting in random target 9 behavior.

The pre-programmed runs and the programmable custom runs provide a method whereby a user may eliminate, restrict, or expand one or more of the random elements of the run.

Pre-programmed runs and programmable custom runs provide a method whereby the user may manually control various aspects of the target 9 behavior while the program is in progress through input to the user interface.

The invention, according to an embodiment, may be configured to randomly select pre-move pause times, move direction, move speed, and move size within the ranges established by run parameters. All such runs will have an element of randomness that will simulate the randomness of an actual moving object. Furthermore, the combined run parameters define minimum and maximum values for each parameter that combine to govern the target 9 behavior. Therefore, runs may be configured for a specific purpose. When a run is repeated, using the same run parameters, minimum and maximum levels of target 9 behavior will be maintained from one run to the next. However, the run pattern will have an element of randomness that will prevent consecutive runs from being identical.

The invention, according to an embodiment, may be configured to randomly set pre-move pause, move speed, move size and move direction in accordance with configured run parameters. A user may eliminate or modify one or more of the random elements of a run to introduce a blend of random and non-random target 9 activity to a run.

The invention, according to an embodiment, includes a manual control option, wherein the user may use buttons 6 on the control panel, FIG. 1, and buttons 22 on the remote transmitter, FIG. 2, to manage the target 9 behavior. Using said buttons, the user may select a target 9 move speed. Using said buttons, the user can cause the target 9 to move in any direction. Using said buttons, the user can cause the target 9 to stop at a desired position.

I claim:

1. A movable target for training and proving with multiple applications comprising: a movable target, at least one user interface, electronic circuitry, a drive motor, said movable target transport apparatus, and programmed routines that are configured to control the behavior of the movable target.

2. A movable target for training and proving with multiple applications as claimed in claim 1, that is capable of making said movable target movements comprising a pre-move pause, a move direction, a move speed, and a move distance.

3. A movable target for training and proving with multiple applications as claimed in claim 2, wherein one or more programmed runs are configured to produce non-random said movable target behavior, comprising one or more said target movements, while maintaining predictable target move characteristics as specified by established run parameters.

4. A movable target for training and proving with multiple applications as claimed in claim 3, wherein one or more said programmed runs are configured to produce random said movable target behavior, comprising one or more said target movements, while maintaining predictable target move characteristics as specified by said run parameters.

5. A movable target for training and proving with multiple applications as claimed in claim 4, wherein a user may create custom said programmed runs through the independent configuration of said run parameters configured to produce random or non-random said movable target behavior, comprising one or more said target movements, while maintaining predictable target move characteristics as specified by said run parameters.

6. A movable target for training and proving with multiple applications as claimed in claim 5, wherein said movable target said random behavior may be eliminated or modified to restrict or expand the level said random behavior.

7. A movable target for training and proving with multiple applications as claimed in claim 6, wherein said user interface may be used to interact with said programmed runs to modify said run parameters while said programmed run is in progress.

8. A movable target for training and proving with multiple applications as claimed in claim 7, wherein said programmed runs may be configured to control said movable target to simulate the actions of live cattle in established equine events, (for example: cutting classes offered by the National Cutting Horse Association or fence classes offered by the National Reined Cow Horse Association).

9. A movable target for training and proving with multiple applications as claimed in claim 8, wherein a manual mode is provided by which said user may use said user interface to manually move said movable target in multiple directions and at a plurality of speeds, and for a plurality of distances.

10. A movable target for training and proving with multiple applications as claimed in claim 9, wherein said user interface may be used to switch from said programmed run to said manual mode. Said programmed run will be suspended while said manual mode is active. Said user interface may be used to switch back to said programmed run which will be completed as defined by said run parameters.

11. A movable target for training and proving with multiple applications as claimed in claim 10, wherein any remote switch closure may be used to start and stop said programmed runs.

12. A movable target for training and proving with multiple applications as claimed in claim 11, wherein a run timer will begin timing at the commencement of said programmed run and stop timing at the completion of said programmed run, and display the elapsed said programmed run time.

13. A movable target for training and proving with multiple applications as claimed in claim 12, wherein a vending method is provided to allow said user to activate said invention for limited usage in exchange for a value received.
